(19) United States
(12) Patent Application Publication
(10) Pub. No.: US 2026/0058807 A1
(43) Pub. Date: Feb. 26, 2026

(54) IDENTITY PROOFING OF AUTONOMOUS AI AGENTS

(71) Applicant: Wells Fargo Bank, N.A., San Francisco, CA (US)

(72) Inventors: Ian Timothy Staley, Seattle, WA (US); Ashmita Regmi, San Francisco, CA (US); Anita Sukur, Minneapolis, MN (US)

(21) Appl. No.: 18/811,370

(22) Filed: Aug. 21, 2024

(51) Int. Cl. H04L 9/08

(52) U.S. Cl. CPC H04L 9/088

(57) ABSTRACT

Examples are directed to systems and methods that enhances security for an autonomous artificial intelligence agent (AAIA). The system receives permissions associated with the AAIA that relate to an action the AAIA is authorized to perform. A passkey is assigned to the AAIA that relates to an authentication type for the AAIA. The system assigns a decentralized identifier (DID) to the AAIA along with a private key.

The private key allows the AAIA to authorize the action. The system receives the passkey from the AAIA and allow the AAIA to perform the action based on the passkey and the permissions associated with the AAIA. The AAIA performs the actions using the DID.

### BACKGROUND

A user may decide to have an autonomous artificial intelligence agent (AAIA) perform various functions. The AAIA can be voice-activated where a user can provide a voice command to the AAIA, such as request information or provide viewing options for various multimedia. The AAIA can also be used to access sensitive information on behalf of the user. In some instances, a software application, such as a bot, can be used to perform certain automated functions that can mimic the behavior of a user. However, the bot can mimic an AAIA and can access sensitive information associated with the user without the consent of the user.

### SUMMARY

Examples relate to a system and method that can identity proof an AAIA that acts on behalf of a user. The AAIA can be specific to a device associated with the user. The AAIA can be identity proofed by assigning a passkey to the AAIA that is used to authenticate the AAIA when the user desires to have the AAIA perform an action on behalf of the user. The passkey can be associated with a user defined authentication type, such as a pass phrase, a personal identification (PIN), a biometric, or the like, that is received when the user desires to have the AAIA perform an action on behalf of the user. The passkey can allow the AAIA to act on behalf of the user. A decentralized digital system can assign a decentralized identifier (DID) to the AAIA that can be used by the AAIA to perform actions on behalf of the user. A private key, which can be different from the passkey, can also be assigned to the AAIA that is used by the AAIA to authorize actions at the decentralized digital system. The user can assign permissions to the AAIA that relate to actions that the AAIA can perform on behalf of the user.

When the user desires to have the AAIA perform an action on behalf of the user, the AAIA can be recognized using the passkey. The AAIA can then perform the action on behalf of the user where the action can be recorded at the decentralized digital system. In particular, a smart contract at the decentralized digital system can execute the action. Moreover, the AAIA can execute a digital signature on behalf of the user to complete the action, which can then be stored at the decentralized digital system.

Different devices associated with the user can have different AAIAs associated therewith. Here, the user can assign different permissions to the different AAIAs such that the different devices can have different permissions to perform different actions on behalf of the user. The decentralized digital system can assign different DIDs to the different AAIAs. In addition, different passkeys can be assigned to the different AAIAs while the different AAIAs can have the same private key in order to allow the different AAIAs to authorize actions at the decentralized digital system.

### BRIEF DESCRIPTION OF FIGURES

FIG. 1 shows an environment in which examples may operate, in accordance with some examples.

FIG. 2 is a method for identity proofing an AAIA and performing an action using an AAIA on behalf of a user, in accordance with some examples.

FIG. 3 is a user interface illustrating an application that can be used to provision an AAIA for a device in FIG. 1, in accordance with some examples.

FIG. 4 illustrates a dashboard that can show permissions associated with a device in FIG. 1 on which the dashboard is displayed via the application in FIG. 3, in accordance with some examples.

FIG. 5 shows a dashboard listing all the permissions for all of the devices associated the user, in accordance with some examples.

FIG. 6 is a block diagram illustrating an example of a machine upon which one or more examples may be implemented.

FIG. 7 illustrates a device that can be used to implement exemplary examples of the present disclosure.

### DETAILED DESCRIPTION

Examples relate to a system and method that can identity proof an AAIA that acts on behalf of a user. The AAIA can be specific to a device associated with the user. The AAIA can be identity proofed by assigning a passkey to the AAIA that is used to authenticate the AAIA when the user desires to have the AAIA perform an action on behalf of the user. The passkey can be associated with a user defined authentication type, such as a pass phrase, a personal identification (PIN), a biometric, or the like, that is received when the user desires to have the AAIA perform an action on behalf of the user. The passkey can allow the AAIA to act on behalf of the user. A decentralized digital system can assign a decentralized identifier (DID) to the AAIA that can be used by the AAIA to perform actions on behalf of the user. A private key can also be assigned to the AAIA that is used by the AAIA to authorize actions at the decentralized digital system. The user can assign permissions to the AAIA that relate to actions that the AAIA can perform on behalf of the user.

The actions can include fiscal transactions at monetary accounts associated with a user, such as withdrawing funds from monetary accounts to remit payment for outstanding bills, transferring funds between accounts, opening new accounts for the user, and the like. Different AAIA agents can have different permissions to perform different actions on behalf of the user. Thus, an AAIA agent associated with a smart phone can have permissions to perform the actions of transferring funds between accounts while also remitting payment for paying bills while an AAIA agent associated with a smart wearable device may only have permission to perform the action of transferring funds between accounts.

To further illustrate, a user may want an AAIA associated with their smart phone to have the ability to pay bills when the user issues a voice command to an application that implements the AAIA. Thus, the user can set as a permission the ability of the smartphone AAIA to pay bills during provisioning. Furthermore, the user can decide that in order to activate the AAIA, an image corresponding to the face of the user is an authentication type that can be required to engage the AAIA.

During provisioning of the AAIA, a decentralized digital system can assign a DID to the AAIA. The AAIA can use the DID to communicate with entities that can facilitate the transfer of funds from an account associated with the user to an account associated with a payee, such as a landlord when the user owes rent to the landlord. A smart contract at the decentralized digital system can effectuate fund transfer from the user account to the payee account. Upon funds transfer, this transaction can be recorded at the decentralized digital system.

By identity proofing an AAIA, examples minimize the possibility of nefarious actors, such as bots, from hacking into accounts associated with a user and withdrawing funds from the accounts. Thus, the system and method described herein minimizes security threats that can occur in computing environments thereby improving the functioning of computing devices. Moreover, by minimizing security threats that can occur in computing environments, examples described herein are firmly rooted in computing devices.

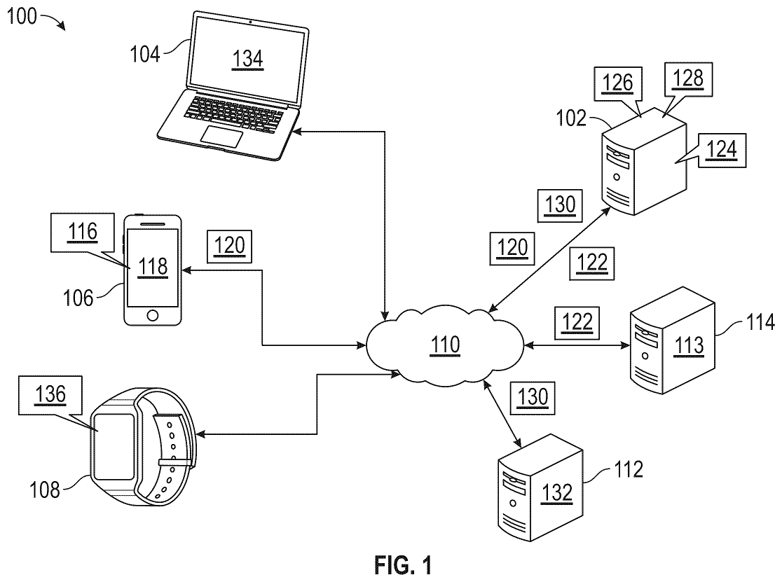

Now making reference to FIG. 1, a network environment 100 is shown in which examples can operate. The network environment 100 can include a server device 102 associated with an entity, such as a financial institution where the server device 102 can be a computing device having hardware and software functionality to perform the features discussed herein. The network environment 100 can also include devices 104-108 that can be computing devices having hardware and software functionality to perform the features discussed herein. The network environment 100 can also include a network 110 along with a decentralized digital system 112. The network 110 can facilitate communication between the server device 102, the devices 104-108, and the decentralized digital system 112. The decentralized digital system 112 can be a network architecture that distributes information processing and control across multiple machines or nodes, such as distributed ledger technology, a blockchain, a graphical database, or the like.

The network 110 can be any network that enables communication between or among machines, databases, and devices (e.g., the server device 102, the device 104-108, and the decentralized digital system 112). The network 110 can be a wired network, a wireless network (e.g., a mobile or cellular network), or any suitable combination thereof. The network 110 may include one or more portions that constitute a private network, a public network (e.g., the Internet), or any suitable combination thereof. Accordingly, the network 110 can include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 110 can communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

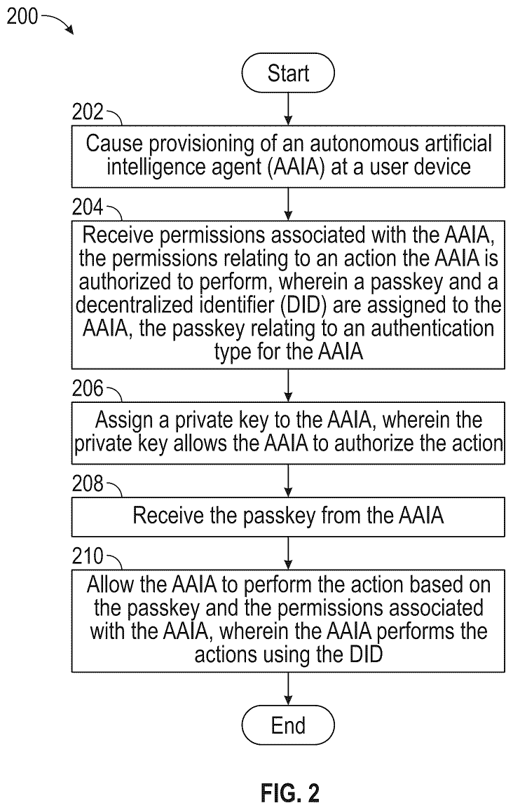

As noted above, examples relate to identity proofing an AAIA. Now making reference to FIG. 2, a method 200 for identity proofing an AAIA and performing an action using an AAIA on behalf of a user is shown. During an operation 202, an AAIA can be caused to be provisioned for a user device. Provisioning the AAIA can include generating a passkey and assigning the passkey to the AAIA. The passkey can be used to engage the AAIA by a user to perform an action on behalf of the user and can be generated with a user selected authentication type. After generation, the passkey can be accessed when the proper authentication, which can correlate to an authentication type, is provided at the device associated with the AAIA. Furthermore, when the passkey is generated, the passkey can be remotely stored, such as at a server device 114.

The authentication type can relate to a type of authentication that is necessary to engage use of the AAIA. The authentication type can be a password, a pass phrase, a PIN, a biometric, or the like. In examples where the authentication type is a biometric that is used to engage use of the AAIA, the authentication can include facial recognition of the user or an iris scan of the user where the device can have image capture capabilities that can capture facial features of the user or scan an iris of the user. The biometric can also include fingerprint recognition where the user can provide their fingerprint. As the authentication type can be user selectable, a user associated with the device can select which type of authentication should be used to engage the AAIA.

In order to provision an AAIA at a user device, the user can download an application onto the user device from an entity that governs objects associated with the user. The objects can include bank accounts, credit accounts such as a home equity line of credit (HELOC), or any other type of account that can hold an asset. The application can include an interface that allows the user to determine the authentication type, which can allow a user to select an authentic type that can be used to engage the AAIA.

Once the authentication type is selected and an authentication is generated, this can be sent to the entity that governs objects associated with the user. The entity can generate a passkey that can be bound to the user device for which the AAIA is provisioned. The passkey can be remotely stored or stored locally at the entity that governs objects associated with the user. In further examples, the user device to which the AAIA can be bound can generate the passkey. The user device can locally store the passkey, can forward the passkey to the entity that governs objects associated with the user, or can forward the passkey to storage that is remote from the user device and the entity that governs objects associated with the user.

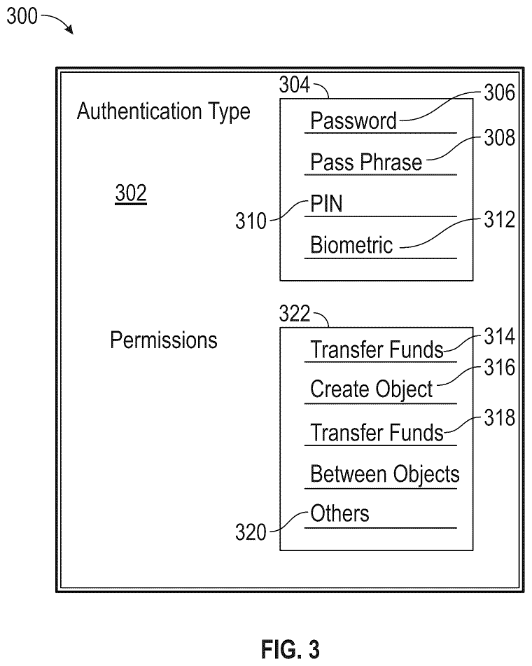

As an illustration of the method 200 and referred to herein as “the illustration,” making reference to FIG. 3, during the operation 202, a user can download an application page 300 that can include a user interface 302 from the server device 102, which can be the entity that governs objects associated with the user. The application 300 can be used to provision an AAIA 116 for the device 106. In the illustration, the device 106 can be a smartphone. The user interface 302 can include a drop-down menu 304 having authentication types 306-312.

The authentication type 306 can correspond to a password. When the authentication type 306 is selected, the user can be directed to another user interface, which allows for the entry of a password. The authentication type 308 can correspond to a pass phrase. When the authentication type 308 is selected, the user can be directed to another user interface, which allows for the entry of a pass phrase. The authentication type 310 can correspond to a PIN. When the authentication type 310 is selected, the user can be directed to another user interface, which allows for the entry of a PIN.

The authentication type 312 can correspond to a biometric. When the authentication type 312 is selected, a feature 118 of the device 106 that facilitates capture of the biometric can be accessed and the biometric can be collected via the device 106 feature. For example, if the biometric is facial recognition or iris recognition, the feature 118 can be an image capture feature. If the biometric is fingerprint recognition, the feature 118 can be a fingerprint capture feature.

In the illustration, the user associated with the user device 106 desires the authentication type to be facial recognition. Thus, the user selects the authentication type 312 and the device feature 118 is accessed in order to facilitate facial recognition during the operation 202 to create an authentication type 120. The user device 106 can send the authentication type 120 to the server device 112. The server device 112 can generate a passkey 122 and send the passkey 122 to the server device 114 for remote storage. The server device 114 can include a keychain 113 where the passkey 122 can be stored at the keychain 113. The keychain 113 can be accessed when a proper authentication type is received at the device 106.

Returning to FIG. 2, after the AAIA is provisioned, the method 200 can perform an operation 204, where permissions associated with the AAIA can be received. The permissions can relate to an action that the AAIA is permitted to perform on behalf of the user at an object associated with the user. As noted in FIG. 2, a passkey can be assigned to the AAIA that can relate to an authentication type for the AAIA using the procedure described with reference to the operation 202.

In addition, the AAIA can have a DID assigned thereto. As described above, the DID can allow the AAIA to communicate with other entities. The DID can be a unique digital identifier that can verify ownership and authenticity of a digital asset, such as a non-fungible token (NFT). The decentralized digital system 112 can assign the DID. In examples, the other entities can have a DID that is different from the DID assigned to the AAIA. The other entities can be objects as described above.

The DIDs can allow the AAIA to perform actions with the other entities. For example, an AAIA can perform the action of transferring funds from a bank account of a user to a mobile wallet. The DID of the AAIA can be used to communicate with the mobile wallet via the DID of the mobile wallet. Furthermore, the decentralized digital system 112 can implement smart contracts, which can effectuate the transfer of funds between the bank account of the user and the mobile wallet.

After performing the operation 204, the method 200 can perform an operation 206, where a private key can be assigned to the AAIA. In examples, the entity that governs objects associated with the user can generate a private key and assign the private key to the AAIA. Alternatively, the private key can already be generated and the entity that governs objects associated with the user can assign the previously generated private key to the AAIA. The private key can be used by the AAIA to provide a digital signature when an action requires a digital signature. A private key can also be used by other entities with whom the AAIA is performing an action to authorize the action. For example, if the AAIA is transferring funds from a HELOC associated with a user to a checking account associated with the user, the private key can be used to provide a digital signature when required by entities associated with the HELOC, the checking account, and the AAIA to complete the action. Furthermore, the private key can be associated with multiple AAIAs while each of the multiple AAIAs have separate passkeys. Thus, examples envision a split key scenario for AAIAs where the AAIAs share a private key while having different passkeys.

Returning to the illustration and FIG. 3, the user interface 302 can also include permissions 314-320 at a drop-down menu 322. The permission 314 can be associated with allowing the AAIA 116 to take the action of transferring funds from an object 124 at the server device 102, which can be a bank account, to an outside entity on behalf of the user. The permission 316 can be associated with allowing the AAIA 116 to take the action of creating an object on behalf of the user, such as opening a bank account for the user. The permission 318 can be associated with allowing the AAIA 116 to take the action of transferring funds between objects on behalf of the user, such as transferring funds between a HELOC associated with the user and a checking account associated with the user. The permission 320 can relate to allowing the user to define additional permissions relating to additional actions the AAIA 116 can take on behalf of the user.

In the illustration, the user decides that the AAIA 116 can take the action of transferring funds from the object 124 associated with the permission 314. Furthermore, the user decides that the AAIA 114 can take the action of transferring funds between objects of the user associated with the permission 318. Therefore, the user selects the permissions 314 and 318. After selection, the server device 102 can receive these permissions from the user device 106 during the operation 204.

In response to receiving the permissions, the server device 102 can generate a private key 126 and assign the private key 126 to the AAIA 116 during the operation 206. In addition to the object 124, the user can be associated with an object 128, which can be a HELOC. Each of the objects 124 and 128 require digital signatures. When performing actions with the objects 124 and 128, the AAIA 116 can use the private key 126 to provide digital signatures.

Still sticking with the illustration, the decentralized digital system 112 can be a blockchain and can generate a DID 130. The DID 130 can be sent to the server device 120. Thus, when the AAIA 116 performs actions with the objects 124 and 128, the AAIA 116 can perform actions with the objects 124 and 128 using the DID 130.

Returning to FIG. 2 and the method 200, during an operation 208, the passkey can be received from a user device at the entity that governs objects associated with the user when a user decides to engage as AAIA to perform an action of the user. The AAIA at the user device can be activated when the proper authentication for the AAIA is provided for the AAIA. After activating the AAIA, a user associated with the user device with which the AAIA is bound can request that the AAIA perform an action on behalf of the user. The request can be received at the user device in the form of a verbal command or the entry of a command at an application at the device, such as the application 300.

When the command is received at the user device, the user device can send a request to the server device for the passkey that is associated with the activated AAIA. The passkey can then be sent to the entity that governs objects associated with the user during the operation 208.

Returning to the illustration and FIG. 1, when the user desires to activate the AAIA 116, the application 300 can be opened and the features 108 can be used to perform facial recognition of the user. Moreover, the user wishes to perform the action of transferring $2000 from the HELOC at the object 128 to the bank account of the user at the object 124. Upon proper authentication, the user device 106 can access the passkey 122 from the server device 114 and can cause the server device 114 to provide the passkey 122 to the server device 102.

Turning back to FIG. 2 and the method 200, during an operation 210, the entity that governs objects associated with the user can allow the AAIA to perform the action based on the passkey and the permissions associated with the AAIA. Here, the AAIA can perform the action using the DID as described above. In particular, when the entity that governs objects associated with the user receives the passkey and the action to be performed, the entity can check the action against the permissions previously received. The entity can also check the password against a list that stores passkeys associated with various AAIAs to confirm that both the AAIA and the passkey are valid. Once validation is complete, the AAIA can perform the action on behalf of the user.

Returning attention to the illustration, the server device 102 can check the action of transferring funds from the object 128 to the object 124 against the permissions previously received. As noted above, the permissions included the ability of the AAIA 116 to perform the action of transferring funds between the objects 124 and 128. Therefore, the server device 102 allows the AAIA 116 to perform the action of transferring $2000 from the object 128 to the object 124. Here, the AAIA 116 uses the DID 130 to perform the action of transferring funds where the DID 130 works with the DID of the objects 124 and 128 to effect the transfer via a smart contract 132 at the decentralized digital system 112. In particular, the smart contract 132 can receive the DID 130 and effectuate the action of transferring $2000 from the object 128 to the object 124. The smart contract 132 can be a self-executing program that executes the action based on the permissions in response to receiving the DID from the AAIA.

Since the decentralized digital system 112 is a blockchain in the illustration, the action of the transfer of $2000 from the object 128 to the object 124 can be recorded at the decentralized digital system 112 as a hash upon completion of the action. In addition, a timestamp associated with when the action of the transfer of $2000 from the object 128 to the object 124 occurred can be recorded at the decentralized digital system 112.

As mentioned above, different devices can have different AAIAs associated therewith. For example, the device 104, which can be a laptop computer, can have an AAIA 134. The AAIA 134 can be provisioned such that the permissions can include the ability to create objects via the permission 316 on behalf of the user in addition to transferring funds between accounts associated with the user and accounts associated with payees in accordance with description above. In addition, the AAIA 134 can be provisioned to transfer funds between accounts associated with the user. A passkey can also be assigned to the AAIA 134 as discussed above with the reference to the passkey 122. The passkey for the AAIA 134, which can be different from the passkey 122, can be used in the same manner as the passkey 122. Here, the AAIA 134 can be bound to the device 104. Moreover, the AAIA 134 can have the private key 126.

The device 108 can be a wearable device, such as a smartwatch, and can have an AAIA 136. The AAIA 136 can be provisioned to transfer funds between accounts associated with the user. A passkey, which can be different from the passkey 122, can also be assigned to the AAIA 136 as discussed above with the reference to the passkey 122. The passkey for the AAIA 136 can be used in the same manner as the passkey 122. Here, the AAIA 136 can be bound to the device 108.

Thus, different devices associated with a single user can have different AAIAs associated therewith that can have different permissions. The AAIA 136 can also have the private key 126.

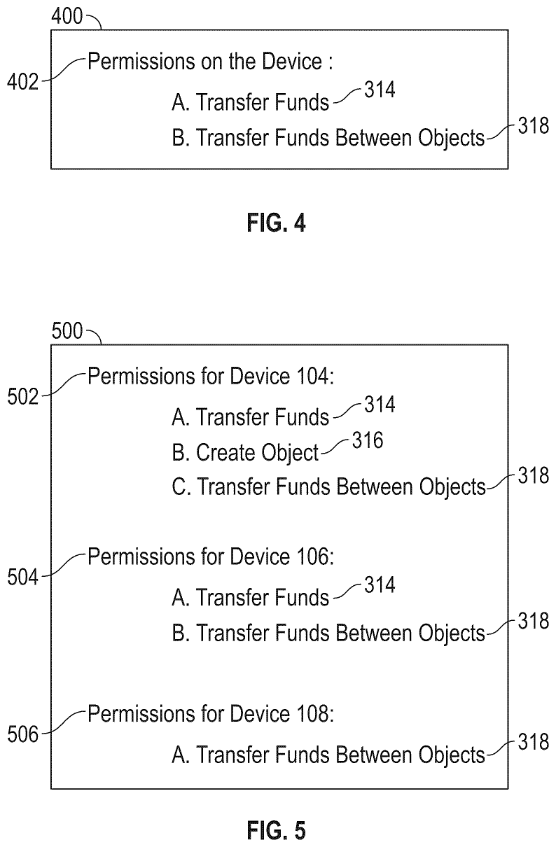

Now making reference to FIG. 4, a dashboard 400 is shown that can show permissions associated with a device on which the dashboard 400 is displayed via the application 300. In the illustration, the AAIA 116 has the permissions 314 and 318. Therefore, when the dashboard 400 is displayed on the user device 106, the dashboard 400 can show that permissions 402 on the device 106 include permissions 314 and 318.

In addition to displaying a dashboard that illustrates permissions for the AAIA specific to the device on which the dashboard is displayed, examples can also include a dashboard 500 that shows all the permissions for all of the devices associated the user. For example, the dashboard 500 can illustrate that permissions 502 for the device 104 include the permissions 314-318. Moreover, the dashboard 500 can illustrate that permissions 504 for the device 106 include the permissions 314 and 318. The dashboard 500 can also show that permissions 506 for the device 108 include the permission 318.

A passkey can have a plurality of authentication types where each authentication type can differ based on a value associated with an action associated with a permission. For example, the permission 314 can relate to transferring funds. The action can relate to transferring funds having a given amount such that the action can include sub-actions corresponding to different amounts. To further illustrate, the action of transferring funds can have a first sub-action of transferring funds between $1 and $1000, a second sub-action of transferring funds between $1001 and $10000, and a third sub-action of transferring funds over $10001.

Each of the sub-actions can correspond to different authentication types to access the passkey. Thus, if a user desires to perform the first sub-action, such as transferring $500, a first authentication may be a biometric. If a user desires to perform the second sub-action, such as transferring $5000, a second authentication may be a biometric in addition to a password and a PIN. If a user desires to perform the third sub-action, such as transferring $15000, a third authentication may be a biometric, a password, a PIN, and a pass phrase. Thus, the passkey can include a plurality of layers where each layer of the plurality of layers can correspond to each sub-action each having a different authentication type.

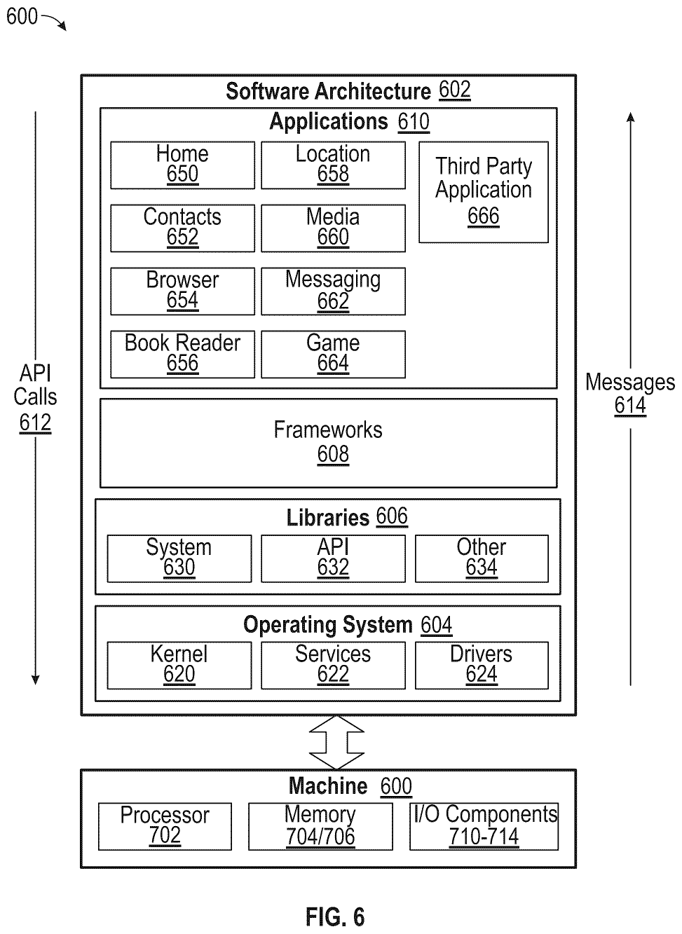

FIG. 6 is a block diagram 600 illustrating a software architecture 602, which may be installed on any one or more of the devices described above. FIG. 6 is merely a non-limiting example of a software architecture, and it will be appreciated that many other architectures may be implemented to facilitate the functionality described herein. The software architecture 602 may be implemented by hardware such as a computer system 700 of FIG. 6 that includes a processor 702, memory 704 and 706, and I/O components 710-714. In this example, the software architecture 602 may be conceptualized as a stack of layers where each layer may provide a particular functionality. For example, the processor 702 includes layers such as an operating system 604, libraries 606, frameworks 608, and applications 610. Operationally, the applications 610 invoke application programming interface (API) calls 612 through the software stack and receive messages 614 in response to the API calls 612, according to some implementations.

In various implementations, the operating system 604 manages hardware resources and provides common services. The operating system 604 includes, for example, a kernel 620, services 622, and drivers 624. The kernel 620 acts as an abstraction layer between the hardware and the other software layers in some implementations. For example, the kernel 620 provides memory management, processor management (e.g., scheduling), component management, networking, and security settings, among other functionality. The services 622 may provide other common services for the other software layers. The drivers 624 may be responsible for controlling or interfacing with the underlying hardware. For instance, the drivers 624 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 606 provide a low-level common infrastructure that may be utilized by the applications 610. The libraries 606 may include system libraries 630 (e.g., C standard library) that may provide functions such as memory allocation functions, string manipulation functions, mathematic functions, and the like. In addition, the libraries 606 may include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 may also include a wide variety of other libraries 634 to provide many other APIs to the applications 610.

The frameworks 608 provide a high-level common infrastructure that may be utilized by the applications 610, according to some implementations. For example, the frameworks 608 provide various graphic user interface (GUI) functions, high-level resource management, high-level location services, and so forth. The frameworks 608 may provide a broad spectrum of other APIs that may be utilized by the applications 610, some of which may be specific to a particular operating system or platform.

In an example, the applications 610 include a home application 650, a contacts application 652, a browser application 654, a book reader application 656, a location application 658, a media application 660, a messaging application 662, a game application 664, and a broad assortment of other applications such as a third-party application 666. According to some examples, the applications 610 are programs that execute functions defined in the programs. Various programming languages may be employed to create one or more of the applications 610, structured in a variety of manners, such as object-orientated programming languages (e.g., Objective-C, Java, or C++) or procedural programming languages (e.g., C or assembly language). In a specific example, the third-party application 666 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 666 may invoke the API calls 612 provided by the mobile operating system (e.g., the operating system 604) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 110 (e.g., the Internet) and via one or more appropriate interfaces (e.g., application program interfaces (APIs).) Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

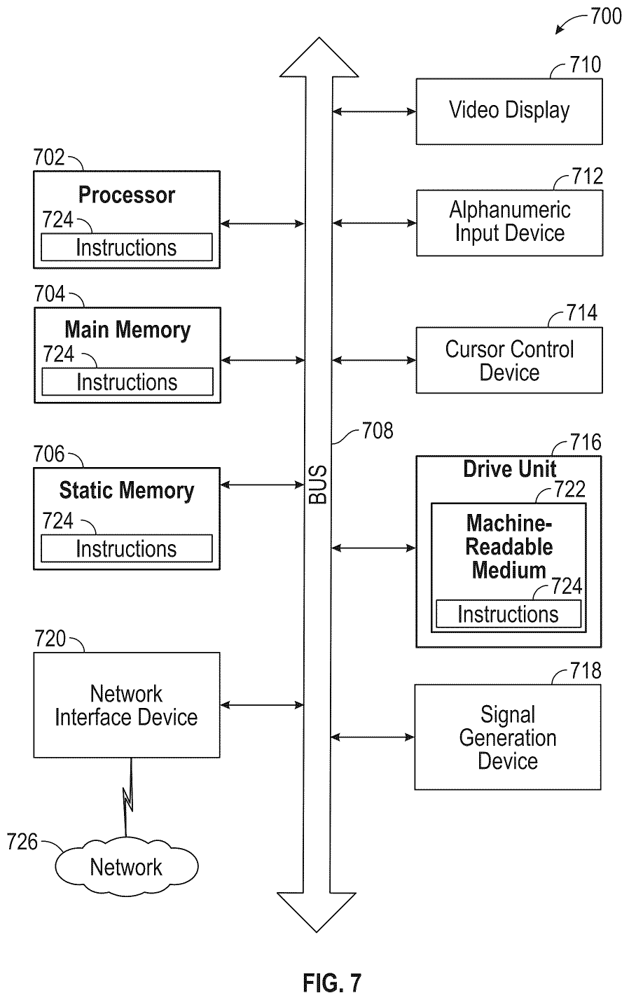

FIG. 7 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 700 includes a processor 702 (e.g., a central processing unit (CPU), a graphics processing unit (GPU), processing circuitry, or any combination thereof), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device (cursor control device) 614 (e.g., a mouse), a disk drive unit 716, a signal generation device 718 (e.g., a speaker) and a network interface device 720.

The drive unit 716 includes a machine-readable medium 722 on which is stored one or more sets of instructions and data structures (e.g., software) 624 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. The instructions 724 may also reside within the static memory 706.

While the machine-readable medium 722 is shown in an example to be a single medium, the term “machine-readable medium” may include a single medium or multiple media (e.g., a centralized or distributed database, and/or associated caches and servers) that store the one or more instructions or instructions 724. The term “machine-readable medium” shall also be taken to include any tangible medium that is capable of storing, encoding or carrying the instructions 724 for execution by the machine and that cause the machine to perform any one or more of the methodologies of the present invention, or that is capable of storing, encoding or carrying data structures utilized by or associated with such instructions 724. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 724 for execution by the machine, and includes digital or analog communications signals or other intangible media to facilitate communication of such software.

In various example examples, one or more portions of the network 726 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 726 or a portion of the network 726 may include a wireless or cellular network, and a coupling may be a Code Division Multiple Access (CDMA) connection, a Global System for Mobile communications (GSM) connection, or another type of cellular or wireless coupling. In this example, a coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology. Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim.

Rather, as the following claims reflect, inventive subject matter lies in less than all features of a single disclosed example. Thus, the following claims are hereby incorporated into the Detailed Description, with each claim standing on its own as a separate example.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system comprising:
processing circuitry; and
a memory device including instructions stored thereon, wherein the instructions, which when executed by the processing circuitry, configure the processing circuitry to perform operations that:
receive permissions associated with an autonomous artificial intelligence agent (AAIA), the permissions relating to an action the AAIA is authorized to perform, wherein:
a passkey is assigned to the AAIA, the passkey relating to an authentication type for the AAIA; and
a decentralized identifier (DID) is assigned to the AAIA;
assign a private key to the AAIA, wherein the private key allows the AAIA to authorize the action;
receive the passkey from the AAIA; and
allow the AAIA to perform the action based on the passkey and the permissions associated with the AAIA, wherein the AAIA performs the actions using the DID.

2. The system of claim 1, wherein the permissions relate to actions that the AAIA can undertake on behalf of the user.

3. The system of claim 1, wherein a plurality of AAIAs are assigned the private key and the plurality of AAIAs are assigned different passkeys.

4. The system of claim 1, wherein the authentication type is one of a password, a pass phrase, a personal identification number (PIN), or a biometric.

5. The system of claim 1, wherein the system includes a remote server device having a keychain that includes the passkey where the keychain is accessed when the authentication type is presented to the remote server device.

6. The system of claim 1, wherein the system includes a decentralized digital system that includes a self-executing program that executes the action based on the permissions in response to receiving the DID from the AAIA.

7. The system of claim 6, wherein the processing circuitry is further configured to perform operations that:
record the action at the decentralized digital system upon execution of the action; and
record a timestamp at the decentralized digital system associated with the execution of the action.

8. The system of claim 6, the processing circuitry is further configured to perform operations that allow the AAIA to communicate with another entity using the DID to perform the action.

9. The system of claim 1, wherein the passkey includes a plurality of layers based on a value associated with the action, the plurality of layers including a plurality of different authentication types where each layer of the plurality of the layers includes a different authentication type.

10. A non-transitory, machine-readable medium, comprising instructions, which when performed by a processor of a machine, causes the processor to perform operations to:
receive permissions associated with an autonomous artificial intelligence agent (AAIA), the permissions relating to an action the AAIA is authorized to perform, wherein:
a passkey is assigned to the AAIA, the passkey relating to an authentication type for the AAIA; and
a decentralized identifier (DID) is assigned to the AAIA;
assign a private key to the AAIA, wherein the private key allows the AAIA to authorize the action;
receive the passkey from the AAIA; and
allow the AAIA to perform the action based on the passkey and the permissions associated with the AAIA, wherein the AAIA performs the actions using the DID.

11. The non-transitory, machine-readable medium of claim 10, wherein the permissions relate to actions that the AAIA can undertake on behalf of the user.

12. The non-transitory, machine-readable medium of claim 10, wherein a plurality of AAIAs are assigned the private key and the plurality of AAIAs are assigned different passkeys.

13. The non-transitory, machine-readable medium of claim 10, wherein the authentication type is one of a password, a pass phrase, a personal identification number (PIN), or a biometric.

14. The non-transitory, machine-readable medium of claim 10, the processing circuitry is further configured to perform operations that:
record the action at a decentralized digital system upon execution of the action; and
record a timestamp at the decentralized digital system associated with the execution of the action.

15. The non-transitory, machine-readable medium of claim 10, the processing circuitry is further configured to perform operations that allow the AAIA to communicate with another entity using the DID to perform the action.

16. The non-transitory, machine-readable medium of claim 10, wherein the passkey includes a plurality of layers based on a value associated with the action, the plurality of layers including a plurality of different authentication types where each layer of the plurality of the layers includes a different authentication type.

17. A method comprising:
receiving permissions associated with an autonomous artificial intelligence agent (AAIA), the permissions relating to an action the AAIA is authorized to perform, wherein:
a passkey is assigned to the AAIA, the passkey relating to an authentication type for the AAIA; and
a decentralized identifier (DID) is assigned to the AAIA;
assigning a private key to the AAIA, wherein the private key allows the AAIA to authorize the action;
receiving the passkey from the AAIA; and
allowing the AAIA to perform the action based on the passkey and the permissions associated with the AAIA, wherein the AAIA performs the actions using the DID.

18. The method of claim 17, wherein:
a plurality of AAIAs are assigned the private key and the plurality of AAIAs are assigned different passkeys; and
the authentication type is one of a password, a pass phrase, a personal identification number (PIN), or a biometric.

19. The method of claim 17 further comprising:
recording the action at a decentralized digital system upon execution of the action; and
recording a timestamp at the decentralized digital system associated with the execution of the action.

20. The method of claim 17, wherein the passkey includes a plurality of layers based on a value associated with the action, the plurality of layers including a plurality of different authentication types where each layer of the plurality of the layers includes a different authentication type.
